(19) United States
(12) Patent Application Publication
(10) Pub. No.: US 2006/0085453 A1
(43) Pub. Date: Apr. 20, 2006

(54) Image replay apparatus

(75) Inventor: Tomonaga Yasuda, Hachioji-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Shibuya-ku (JP)

(21) Appl. No.: 11/244,570

(22) Filed: Oct. 6, 2005

(30) Foreign Application Priority Data
Oct. 15, 2004 (JP) 2004-302276

(51) Int. Cl. G06F 17/30

(52) U.S. Cl. 707/100

(57) ABSTRACT

An image replay apparatus comprises an image selection unit for selecting an image; a control content instruction unit for instructing control content for an image; and a control file creation unit for creating a control file which describes control content instructed by the control content instruction unit for a plurality of images selected by the image selection unit and a list of the plurality of images described by one collective description format.

### CROSS REFERENCE TO RELATED APPLICATIONS

This application is based upon and claims the benefit of priority from the prior Japanese Patent Application No. 2004-302276, filed Oct. 15, 2004, the entire contents of which are incorporated herein by reference.

### BACKGROUND OF THE INVENTION

1. Field of the Invention

The present invention relates to an image replay apparatus for reading and writing a control file which has a description of control content for an image expressed by an image file.

2. Description of the Related Art

An image replay apparatus such as a digital camera is disposed for reading image information stored in a removable memory card or built-in flash ROM (Read Only Memory) as a file to display on a screen such as TFT (thin film transistor) display.

In recent years, there have been a number of image replay apparatuses capable of handling reading and writing of a control file which has a description of information relating to such an image file, content to be processed at the time of image replay and instruction content for another device when the memory card is inserted into the aforementioned device. For example, an apparatus conforming to the DPOF (Digital Print Order Format) or MPV (MultiPhoto/Video) standard belongs to this category. The control file is created or updated when a certain operation is carried out on either one or a plurality of image files. And a digital camera, et cetera, with a photographing function is configured to create or update a control file simultaneously with photographing and refer to the control file when replaying an image or using the memory card in another device. Such a technique makes image information or the content of control instruction comprehensible based on the content of a control file when using a removable medium inserted into various devices for example, thereby shortening the time spent to collect information by processing for, or checking, the image file per se, hence providing a wide range of versatility.

### SUMMARY OF THE INVENTION

One aspect of the present invention is an image replay apparatus comprising an image selection unit for selecting an image; a control content instruction unit for instructing control content for an image; and a control file creation unit for creating a control file which describes control content instructed by the control content instruction unit for a plurality of images selected by the image selection unit and a list of the plurality of images described by one collective description format.

### BRIEF DESCRIPTION OF THE DRAWINGS

FIG. 1 shows a primary comprisal of a digital camera comprising an image replay apparatus according to an embodiment of the present invention;

FIG. 2 is a flow chart relating to a replay operation of a digital camera;

FIG. 3 shows a file structure of an image file stored by a detachable memory;

FIG. 4 exemplifies description content of a control file;

FIG. 5 exemplifies description content of a control file;

FIG. 6 exemplifies description content of a control file;

FIG. 7 exemplifies description content of a control file;

FIG. 8 exemplifies description content of a control file;

FIG. 9 exemplifies description content of a control file;

FIG. 10 exemplifies description content of a control file;

FIG. 11 exemplifies description content of a control file; and

FIG. 12 exemplifies description content of a control file.

### DESCRIPTION OF THE PREFERRED EMBODIMENTS

The following is a detailed description of the preferred embodiment of the present invention while referring to the accompanying drawings.

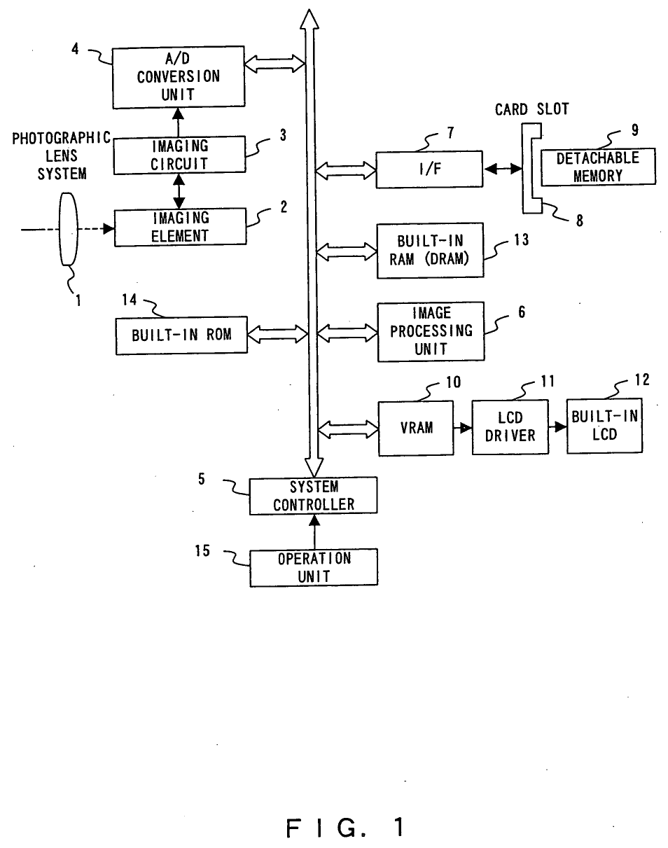

FIG. 1 shows a primary comprisal of a digital camera comprising an image replay apparatus according to an embodiment of the present invention.

Referring to FIG. 1, the digital camera is configured so that an object image focused by a photographic ( ) lens system 1 is photo-electrically converted into an electric signal by an imaging element 2, followed by prescribed image processing by an imaging circuit 3 and A/D (analog/digital) converted by an A/D conversion unit 4. Then, the post-A/D converted digital data (i.e., image data) is subjected to a prescribed image processing by a system controller 5, image compression processing by an image processing unit 6 and is to be stored by a detachable memory 9 inserted into a card slot 8 by way of an I/F (interface) 7 as an image file.

Meanwhile, an image file recorded in the detachable memory 9 is read out thereof by way of the card slot 8 and I/F 7 on an as required basis, is processed for prescribed decompression by the image processing unit 6, which is followed by the system controller 5 carrying out a prescribed image processing, a VRAM (Video RAM (Random Access Memory)) 10 storing it, an LCD (liquid crystal display) driver 11 reading out thereof and a built-in LCD 12 displaying the image.

Also referring to FIG. 1, a DRAM (Dynamic Random Access Memory) 13, i.e., a built-in RAM, is disposed as temporary storage for post-A/D converted image data converted by the A/D conversion unit 4 and for image data being processed by the image processing unit 6, and as a work area for the system controller 5 carrying out control processing such as the creation and update of a later described image control file (simply “control file” hereinafter). The system controller 5, comprising a CPU (Central Processing Unit), controls the entire operation of the aforementioned digital camera by reading a camera program stored by a built-in ROM (Read Only Memory) 14 and executing it.

An operation unit 15, comprising a series of buttons and switches disposed for receiving various operator instructions such as image selection and control content relating to the image, notifies the system controller 5 of the received operator instruction.

The following description is of replay operation of the digital camera as comprised above.

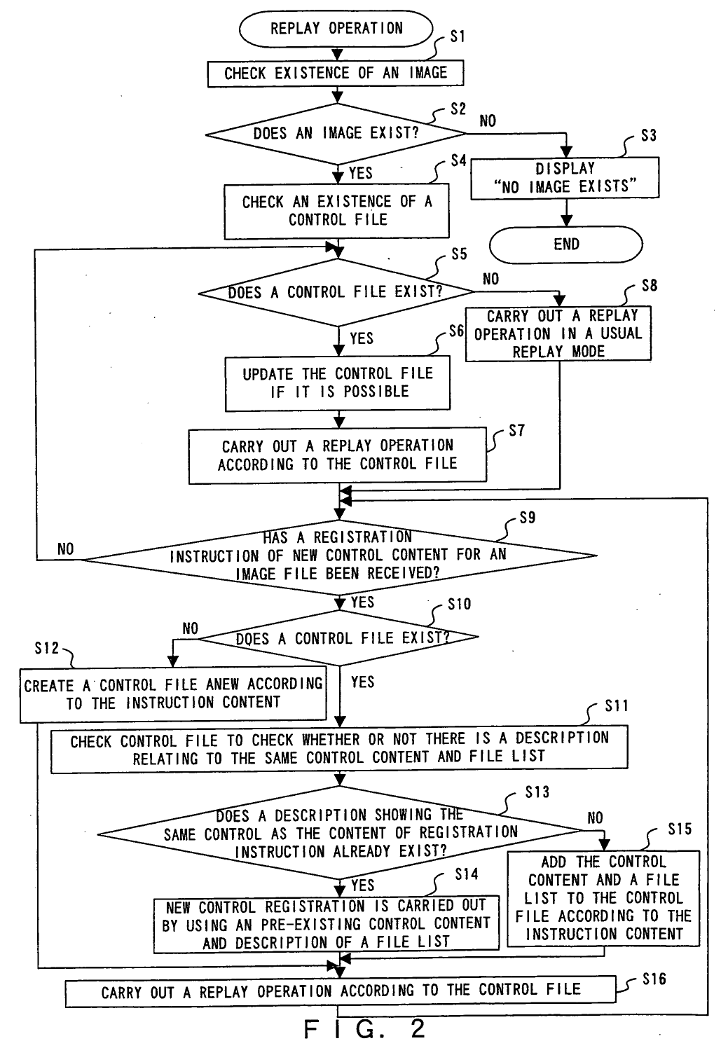

FIG. 2 is a flow chart relating to replay operation of the digital camera, in particular showing a starting operation when starting the aforementioned camera in a replay mode.

This operation first checks for the presence or absence of an image file recorded in the detachable memory 9 which is inserted into the card slot 8 (step 1; simply “S1” hereinafter) to judge whether or not an image file exists (S2).

If the judgment result in S2 is “no”, the processing displays “Image does not exist” in the built-in LCD 12 (S3) and ends the present processing flow.

On the other hand, if the judgment result for S2 is “yes”, the next step is to check for the presence or absence of a control file recorded in the detachable memory 9 (S4) to judge whether or not a control file exists (S5).

Note that the present embodiment defines a control file as a file which contains a description of at least control content for images expressed by one or more image files recorded in a storage medium (e.g., the detachable memory 9) and a list of images expressed by one or more image files relating to the control content. Here, the control content includes a print image designation, a storage image designation, a slide show image designation and a protected image designation, for example.

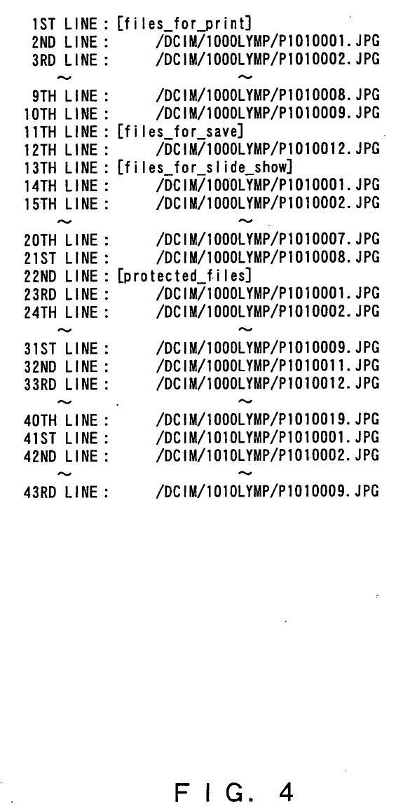

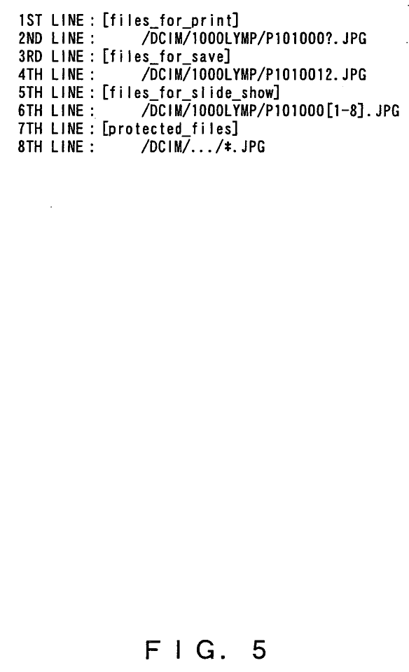

If the judgment result for S5 is “yes” and if there is a control file whose description can be changed from a list of a plurality of images to a list by describing it in one collective description format , the subsequent processing is to update the control file by changing the description to the aforementioned list from the list of a plurality of images described therein (S6). Note that a description of the change in this event will be described later by referring to FIGS. 4 and 5.

The S6 is followed by a replay operation according to the control file recorded in the detachable memory 9 (S7). If there is a plurality of control files recorded in the detachable memory 9, a replay operation will be carried out according to one control file selected by the user. In this case, names of the plurality of control files are displayed by the built-in LCD 12 in the form of a catalog for example, and a replay operation will be carried out according to one control file selected from among the catalog displayed as a result of the user operating the operation unit 15.

Note that, in S7, the replay operation according to a control file is defined as a replay operation for displaying an image expressed by an image file designated as a print image and also a print-use icon in the built-in LCD 12 if control content described in the control file is designated for printing the image, for example. Or, if it is designated for a slide show, the replay operation is for displaying an image expressed by the image file designated for the slide show in the built-in LCD 12 by a slide show format, for example.

In the meantime, if the judgment result for S5 is “no”, a replay operation is carried out in the normal replay mode (S8).

The step S7 or S8 is followed by judging whether or not instructions for registering a control content anew for images expressed by one or more image files, which have been selected by the user operating the operation unit 15, has been received (S9) and, if the judgment result is “yes”, proceeds to S10, while if “no”, then returns to S5 for repeating the above described processing.

Incidentally, an instruction by the user for registering control content anew for an image expressed by an image file is carried out by the user operating the operation unit 15 to let the built-in LCD 12 display an index of images expressed by the image files recorded in the detachable memory 9, selecting one or more desired images from among the index of images, then letting the built-in LCD 12 display a catalog of control content which can be instructed by the current digital camera and instructing desired control content from among the catalog display, for example. Alternatively, it is possible to instruct first desired control content, followed by selecting one or more desired images. This enables the user to instruct registration of control content anew for a desired image, or images, expressed by one or more image files.

Note that the present embodiment is configured to receive an instruction for registering control content anew for an image expressed by an image file in S9, it is, however, possible to configure the current digital camera connectable to an external apparatus so as to receive the instructions by way thereof for example, or possible to utilize a clock function comprised by the current digital camera, thereby allowing the current digital camera to provide instructions for registering prescribed control content automatically at a predetermined time, or making it possible to equip the current digital camera with a function of detecting an environmental change such as in temperature, thereby allowing the current digital camera to provide instructions for registering prescribed control content automatically if the detection result exceeds a predetermined value. For example, if it is configured to provide instructs for registering (NB: simply “registration instructions” in a noun form hereinafter unless otherwise noted) a designation of slide show images for images expressed by a specific plurality of image files at a certain clock time for example, a slide show will be carried out for the images expressed by the specific plurality of image files at the prescribed time.

A “yes” judgment at S9 is followed by S10 to judge whether or not a control file exists in the detachable memory 9 again.

If the judgment result for S10 is “yes”, the subsequent step is to check the control file recorded in the detachable memory 9, and then check the existence of a control file in which the same control content as the one per the registration instructions by the user in S9 and a list of the related images are both described (S11) to judge the presence or absence of the control file in which the same control content as the one specified by the registration instruction is described (S13).

If the judgment for S13 is “yes”, the next step is to change the description of a list of images relating to the same control content as described in the control file into a list which is described by one collective description format for the aforementioned list of images and a list of images expressed by one or more image files as per the registration instructions in S9 to update the control file (S14). Note that a description of the change in this event will be described in detail later by referring to FIGS. 5 through 7. This carries out the registration of new control content according to the instruction given in S9.

Meanwhile, in the judgment for S14, if there is a plurality of control files in which the same control content as the one as per the registration instructions in S9, the present embodiment is to process one or more control files selected by the user operating the operation unit 15. Alternatively, it is possible to process each of the plurality of control files.

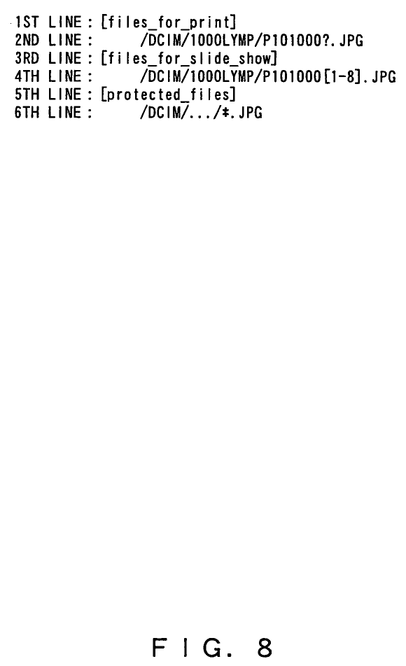

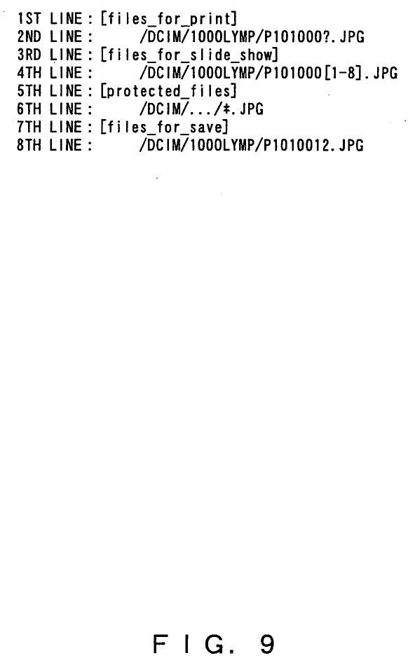

On the other hand, if the judgment result for S13 is “no”, the next step is to add new control content, to the control file, for images expressed by one or more image files to update the control file (S15). That is to add, to the control file, the control content for images expressed by the one or more image files and a list of images expressed by the one or more image files to update the control file. In this event, if there is a list of images expressed by a plurality of image files to be added, the list of images expressed by the plurality of image files will be described as a list described by one collective description format. Incidentally, the addition carried out in this event will be described later in detail by referring to FIGS. 8 and 9. This carries out the registration of a new control instruction according to the instructions given in S9.

Also in S15, if a plurality of control files exists in the detachable memory 9, the control is such as to process the one or more control files selected from among them by the user operating the operation unit 15. Or, it is also possible to process each of the plurality of control files.

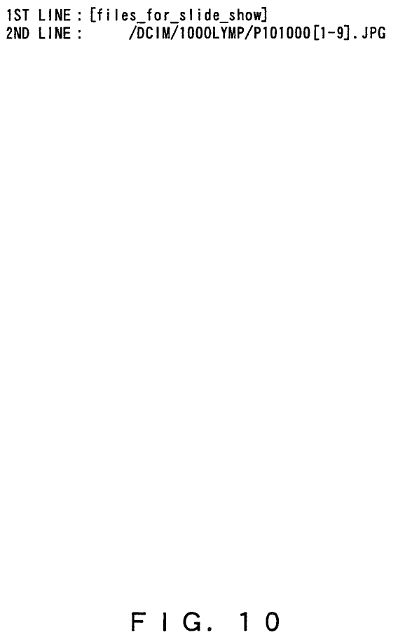

Meanwhile, if the judgment result for S10 is “no”, the next step is to create a control file anew in which new control content for images expressed by one or more image files the registration instructions in S9 to record in the detachable memory 9 (S12). That is, to create and record a control file in which control content for the images expressed by the one or more image files and a list of images expressed by the one or more image files. If a list of images to be described is the one expressed by a plurality of image files, the list of files expressed by the plurality of image files will be described as a list described by one collective description format. Incidentally, the description carried out in this event will be described later in detail by referring to FIG. 10. This carries out the registration of a new control instruction according to the instructions given in S9.

The step S12, S14 or S15 are followed by carrying out a replay operation according to the control file created anew in S12, or according to the one updated in S14 or S15 (S16). If a plurality of control files has been updated in S14 or S15 when carrying out a replay operation according to the control file updated in S14 or S15, the replay operation will be carried out according to one control file selected from among the plurality of control files, selected by the user operating the operation unit 15. Alternatively, it is also possible to configure so as to let the current digital camera select one control file automatically and carry out a replay operation accordingly.

After S16, control returns to S9 to repeat the above described processing.

The next description is of an example of a control file which is processed by the above described flowchart.

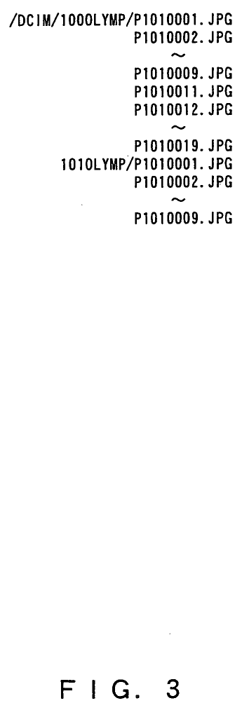

The first description is of an example 1, that is, a description of carrying out the processing of S6 when the detachable memory 9 has a record of image files of the file structure shown by FIG. 3 and a control file with the description content shown by FIG. 4.

Referring to FIG. 4, note that the first line “files_for_print”, eleventh line “files_for_save”, thirteenth line “files_for_slide_show”, and twenty-second line “protected_files” denote control contents of the print image designation, storage image designation, slide show image designation and protected image designation respectively.

And the second through tenth lines show a list of images expressed by the image files designated for image print, the twelfth line shows that expressed by the image file designated for image storage, the fourteenth through twenty-first lines show that expressed by the image files designated for slide show and the twenty-third through forty-third lines show that expressed by the image files designated as protected images, all showing the lists of images expressed by the respective image files in the form of file path/file name.

When the detachable memory 9, storing such image files and a control file, is inserted and the processing of S6 is carried out, the description content of the control file shown by FIG. 4 is changed to the description content of the control file shown by FIG. 5, thus carrying out an update of the control file. That is, the list of the plurality of images designated for image print as shown by the second through tenth lines of FIG. 4 is changed to the list described by one collective description format shown by the second line of FIG. 5, the list of the plurality of images designated for a slide show as shown by the fourteenth through twenty-first lines of FIG. 4 is changed to the list described by one collective description format shown by the sixth line of FIG. 5, the list of plurality of images designated for image protection as shown by the twenty-third through forty-third lines of FIG. 4 is changed to the list described by one collective description format shown by the eighth line of FIG. 5, thus carrying out update of the control file.

Incidentally in FIG. 5, a “?” in the second line is for specifying all the image files with file names including one character of any kind in place of “?”. The sixth line is for specifying eight image files from “P1010001.JPG” through “P1010008.JPG” under the directory “/DCIM/100OLYMP”. Here, an “x” and “y” used for describing [x-y] can only be the natural numbers 0 through 9, with a description of [1-8] meaning only the continuous natural numbers 1 through 8. The eighth line is for specifying all the image files with the extension “JPG” existing under the directory “/DCIM”.

The next description is of an example 2, that is, a description example obtained by carrying out the processing of S14 when the detachable memory 9 has a record of image files with the file structure shown by FIG. 3 and a control file with the description content shown by FIG. 5. Note that the present embodiment assumes new registration instructions designating image storage for an image file “/DCIM/100OLYMP/P10100014.JPG” in the above described step S9.

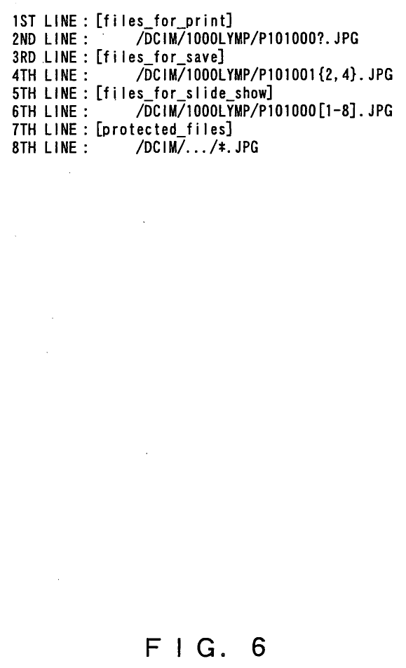

When the processing of S14 is carried out in the above described case, the description content of the control file shown by FIG. 5 is changed to the description content of the control file shown by FIG. 6, thus updating the control file. That is, a list of images expressed by image files relating to a storage image designation which is the same control content as the one of the registration instructions, that is, the list of images specified as storage images shown by the fourth line of FIG. 5, is changed to the list shown by the fourth line of FIG. 6, which describes the list of aforementioned images and the list of the image expressed by the image file specified by the registration instruction by one collective description format, thus updating the control file.

Changing the description of the example 2 is carried out by the following procedure, for example.

First, procedure 1 is to compare the character strings of the file path/file name “/DCIM/100OLYMP/P1010012.JPG”, which is a list of image expressed by image file relating to the tag “[files_for_save]” expressing the same control content as the control content of the registration instruction in S9, and file path/file name “/DCIM/100OLYMP/P1010014.JPG”, which is the list of image expressed by the image file of the registration instructions in S9.

The subsequent procedure 2 describes content by one collective description format, using parentheses “{” and “}” for parts that have changed, and using “,” within the parentheses, as a result of the above described comparison, thereby changing the description content shown by the fourth line of FIG. 5 to the one shown by the fourth line of FIG. 6.

The next description is of an example 3, that is, another description example in which carrying out the processing of S14 when the detachable memory 9 has a record of image files with the file structure shown by FIG. 3 and control file with the description content shown by FIG. 5. Note that the present embodiment assumes new registration instructions designating a slide show for an image file “/DCIM/100OLYMP/P1010009.JPG” in the above described step S9.

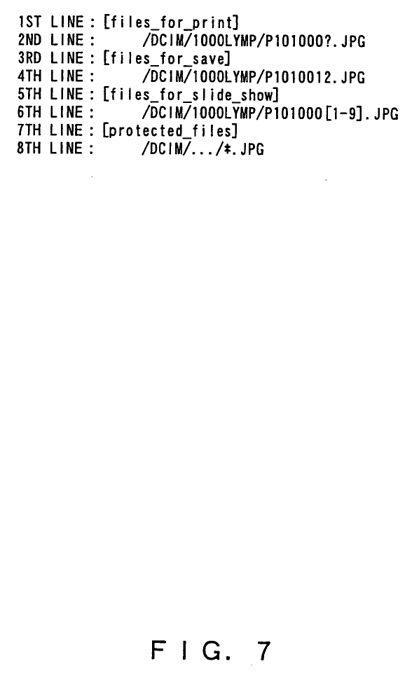

When the processing of S14 is carried out in the above described case, the description content of the control file shown by FIG. 5 is changed to the description content of the control file shown by FIG. 7, thus updating the control file. That is, a list of images expressed by image files relating to a slide show designation which is the same control content as that of the registration instructions, that is, the list of images designated for a slide show shown by the sixth line of FIG. 5, is changed to the list shown by the sixth line of FIG. 7, which describes the list of aforementioned images and the list of image expressed by the image file designated by the registration instructions by one collective description format, thus updating the control file.

Changing the description content of the example 3 is carried out by the following procedure, for example.

First, the procedure 1 compares the character strings, from the first character, of the file path/file name “/DCIM/100OLYMP/P101000[1-8].JPG”, which is a list of images expressed by the image files relating to the tag “[files_for_slide_show]” expressing the same control content as the control content of the registration instruction in S9, and file path/file name “/DCIM/100OLYMP/P1010009.JPG”, which is the list of image expressed by the image file of the registration instruction in S9.

In the subsequent procedure 2, if the above described comparison finds the left parenthesis (i.e., “[”) in the file path/file name described in the control file, it then searches for the right parenthesis (i.e., “]”) and stores the character strings in between (i.e., “1-8” in the present embodiment).

The subsequent procedure 3 compares the character string following the right parenthesis “]” of the file path/file name described in the control file with the file path/file name per the registration instruction upstream from the last character in sequence, and character by character, thereby confirming that a difference can only be found by the right parenthesis “]” which is a character in the file path/file name described in the control file.

The subsequent procedure 4 is to obtain an unsearched character string (i.e., “9” in the present embodiment) from among the character strings in the file path/file name per the registration instruction which has been determined through the above described procedures 1 through 3 and confirm that it is one character.

The subsequent procedure 5 is to check whether the character obtained by the procedure 4 can be described collectively by changing the characters in the parentheses (i.e., “1-8” in the present embodiment) which have been obtained by the procedure 2, that is, to check whether it can be described by one collective description format.

The subsequent procedure 6 is to describe it collectively if the result of the check in the procedure 5 is that it is collectively describable. That is to be describable in one collective description format “/DCIM/100OLYMP/P101000[1-9].JPG”.

The next description is of a description example 4, that is, another description example by carrying out the processing of S15 when the detachable memory 9 has a record of image files of the file structure shown by FIG. 3 and a control file with the description content shown by FIG. 8. Note that the present embodiment assumes new registration instructions designating for image storage an image file “/DCIM/100OLYMP/P1010012.JPG” in the above described step S9.

When the processing of S15 is carried out in the above described case, the description content of the control file shown by FIG. 8 is changed to the description content of the control file shown by FIG. 9, thus updating the control file. In this case, however, an image storage designation which is the same control content as the one per the registration instructions is not described and therefore the content per the registration instructions is added to the description of the control file shown by FIG. 8, resulting in the description content of the control file shown by FIG. 9. That is, the control content “[files_for_save]” per the registration instructions is added to the seventh line and a list of image “/DCIM/100OLYMP/P1010012.JPG” expressed by the image file related to the control content is added to the eighth line, as shown by FIG. 9.

The next description is of an example 5, that is, another description example of carrying out the processing of S12 when the detachable memory 9 has a record of image files of the file structure shown by FIG. 3 and no control file. Note that the present embodiment assumes new registration instructions designating for a slide show images expressed by nine image files from “P1010001.JPG” to “P1010009.JPG” under “/DCIM/100OLYMP” in the above described step S9.

When the processing of S12 is carried out in the above described case, a control file described by the content shown by FIG. 10 is created and then recorded to the detachable memory 9. Here, a list of images expressed by the nine image files is described by a list, “/DCIM/100OLYMP/P101000[1-9].JPG”, which is described by one collective description format as shown by the second line of FIG. 10.

As described above, the present embodiment makes it possible to describe a list of images expressed by a plurality of image files as a list described by one collective description format, hence making the size of a control file small, shortening the time for reading in the control file, searching an image and identifying an image; and reducing a usage volume of temporary memory (i.e., DRAM 13). This accordingly enables provision of a digital camera comprising a versatile, low cost image replay apparatus.

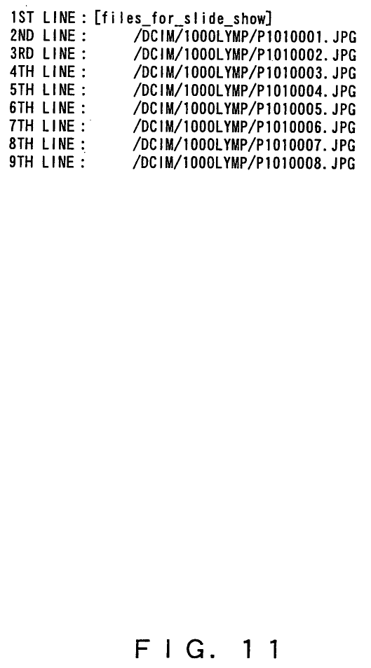

Note that the present embodiment can eliminate the processing of S6 shown by FIG. 2. In such a case, when new registration instructions for a slide show designation for the image file “/DCIM/100OLYMP/P1010009.JPG” is given in step S9 for example, with the detachable memory 9 having a record of image files with the file structure shown by FIG. 3 and a control file of the description content shown by FIG. 11, S14 changes the description content of the control file shown by FIG. 11 to that of the control file shown by FIG. 10, thus updating the control file.

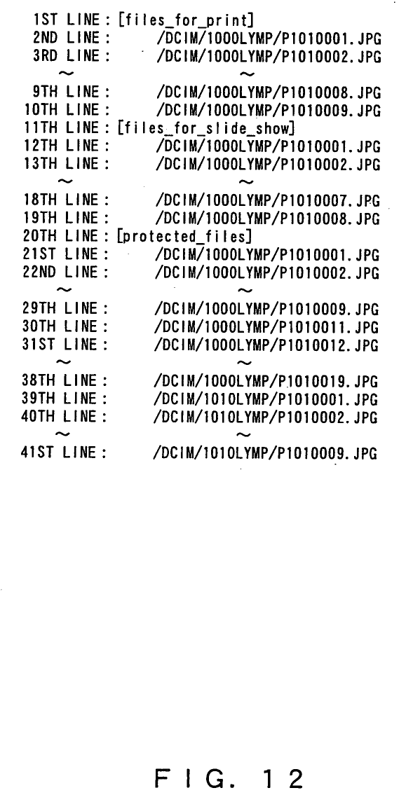

Also, the present embodiment can eliminate the processing of S6 shown by FIG. 2 and allow S14 and S15 cover the processing thereof. In such a case, when new registration instructions for a slide show designation for the image file “/DCIM/100OLYMP/P1010009.JPG” are given in step S9 for example, with the detachable memory 9 having a record of image files with the file structure shown by FIG. 3 and a control file of the description content shown by FIG. 4, S14 changes the description content of the control file shown by FIG. 4 to that of the control file shown by FIG. 7, thus updating the control file. And, when new registration instructions for storing an image to the image file “/DCIM/100OLYMP/P10100014.JPG” are given in the step S9 for example, with the detachable memory 9 having a record of image files with the file structure shown by FIG. 3 and a control file of the description content shown by FIG. 12, step S15 changes the description content of the control file shown by FIG. 12 to that of the control file shown by FIG. 9, thus updating the control file.

Also the present embodiment can be so configured as to allow S9 shown by FIG. 2 alone to instruct control content for example and either S12, S14 or S15 to select images expressed by one or more image files as the subject of the control content accordingly, instead of the above described configuration in which the user selects images expressed by one or more image files and also instructs control content for the selected images expressed by the one or more image files in S9.

In such a case, the processing in S12 or S15 with regard to describing a list of images to the control file is such that, as the user selects an image expressed by an image file, a list of the image expressed by the image file is described in the control file so that, subsequently, every time the user continuously selects an image expressed by an image file one after another, a list of images which has been described at the time of the previous selection will be changed to a list described by one collective description format, comprising a list of the image expressed by the currently selected image file and that which has been described at the time of the previous selection.

Likewise in S14, with regard to describing a list of images to the control file is such that, as the user selects an image expressed by an image file, a list of images already described in the control file is changed to a list, described by one collective description format, comprising a list of the image expressed by the selected image file and that which has been described in the control file so that, subsequently, every time a user continuously selects an image expressed by an image file one after another, a list of images which has been described at the time of the previous selection will be changed to a list, described by one collective description format, comprising a list of the image expressed by the currently selected image file and that which has been described at the time of the previous selection.

Such a configuration makes it possible to further reduce a usage volume of temporary memory (i.e., DRAM 13) at the time of either creating or updating the control file.

Note it goes without saying that the above described present embodiment, while described in detail, in no way limits the present invention and rather can be improved or changed in various ways within the scope of the present invention.

As described above in detail, the present invention reduces the size of a control file, hence shortening the time for reading the file, searching for an image and identifying the image, thereby reducing the usage volume of temporary memory. Therefore, the present invention enables the provision of a versatile, low cost image replay apparatus.

What is claimed is:

1. An image replay apparatus comprising:
an image selection unit for selecting an image;
a control content instruction unit for instructing control content for an image; and
a control file creation unit for creating a control file which describes control content instructed by the control content instruction unit for a plurality of images selected by the image selection unit and a list of the plurality of images described by one collective description format.

2. An image replay apparatus comprising:
an update unit for updating a control file by changing a list of a plurality of images to a list described by one collective description format if there is the control file which describes control content for the plurality of images and the list of the plurality of images.

3. An image replay apparatus comprising:
an image selection unit for selecting an image;
a control content instruction unit for instructing control content for an image; and
an update unit for updating a control file by adding control content for a plurality of images and a list of the plurality of images described by one collective description format to the control file if there is the control file which does not describe the same control content as the one instructed by the control content instruction unit for the plurality of images selected by the image selection unit.

4. An image replay apparatus comprising:
an image selection unit for selecting an image;
a control content instruction unit for instructing control content for an image; and
an update unit for updating a control file by changing a list of images relating to the same control content as that described in the control file to a list which describes, in one collective description format, the list of images and a list of a single or plurality of images selected by the image selection unit if there is the control file which describes the same control content as the one instructed by the control content instruction unit for the single or plurality of images selected by the image selection unit.

5. An image replay apparatus comprising:
an image selection unit for selecting an image;
a control content instruction unit for instructing control content for an image; and
an update unit for updating a control file by changing a list describing, in one collective description format, a list of a plurality of images which relates to the same control content as that described in the control file to a list describing, in one collective description format, the list of the plurality of images and a list of a single or plurality of images selected by the image selection unit if there is the control file which describes the same control content as the one instructed by the control content instruction unit for the single or plurality of images selected by the image selection unit.

6. A creation method for a control file, comprising the steps of
selecting a plurality of images;
instructing control content for the selected plurality of images; and
creating a control file which describes the instructed control content and a list of the selected plurality of images described by one collective description format.

7. An update method for a control file, comprising the step of
updating a control file by changing a list of a plurality of images to a list described by one collective description format if there is the control file which describes control content for the plurality of images and the list of the plurality of images.

8. An update method for a control file, comprising the steps of
selecting a plurality of images;
instructing control content for the selected plurality of images; and
updating a control file by adding the instructed control content and a list of the plurality of images described by one collective description format to the control file if there is the control file which does not describe the same control content as the instructed control content.

9. An update method for a control file, comprising the steps of
selecting a single or plurality of images;
instructing control content for the selected single or plurality of images; and
updating a control file by changing a list of images relating to the same control content as that described in the control file to a list which describes, in one collective description format, the list of images and a list of the selected single or plurality of images if there is the control file which describes the same control content as the instructed control content.

10. An update method for a control file, comprising the steps of
selecting a single or plurality of images;
instructing control content for the selected single or plurality of images; and
updating a control file by changing a list which describes, in one collective description format, a list of a plurality of images relating to the same control content as that described in the control file to a list which describes, in one collective description format, the list of the plurality of images and a list of the selected single or plurality of images if there is the control file which describes the same control content as the instructed control content.
